(19) United States
(12) Patent Application Publication
(10) Pub. No.: US 2004/0112961 A1
(43) Pub. Date: Jun. 17, 2004

(54) Printing paper

(75) Inventor: Motoshige Asano, Asaka-shi (JP)

Correspondence Address: SUGHRUE MION PLLC, 2100 Pennsylvania Avenue, NW, Washington, DC, 20037-3213, US

(73) Assignee: FUJI PHOTO FILM CO., LTD

(21) Appl. No.: 10/728,744

(22) Filed: Dec. 8, 2003

(30) Foreign Application Priority Data
Dec. 11, 2002 (JP) 2002-359416

(51) Int. Cl. G06F 3/12; G06F 15/12; G06K 19/00

(52) U.S. Cl. 235/432; 235/487

(57) ABSTRACT

Roll printing paper is provided at a high security level and a lower cost by accepting roll paper only corresponding to a printer. When printing paper is used by mounting it in a printer, a photosensor scans and reads an information code on the end face of a paper pipe while it is rotating, and a photosensor scans and reads an information code of roll paper, thereby determining whether or not they correspond to each other. If they correspond to each other, it is determined that the paper pipe is loaded with predetermined rotor. If they do not correspond to each other, it is determined that the paper pipe is loaded with wrong roll paper.

### BACKGROUND OF THE INVENTION

1. Field of the Invention

The present invention relates to printing paper for use on a printer, and more specifically to long printing paper rolled around a core pipe.

2. Description of the Related Art

In a photoprinter and a thermal printer, roll paper is used. The roll paper is produced by rolling long printing paper or thermal paper around a core pipe (also referred to as a paper pipe) cylindrically formed by used corrugated paper, and cut in a predetermined size after printing. These printing paper and thermal paper are set on a printer and drawn as necessary each time printing is performed.

Recently, a Print Club machine is mounted in a game arcade, a spa, a supermarket, etc. In the Print Club machine, a taken image is printed on roll paper, cut in a predetermined size, and presented to a user.

Roll paper corresponding to the Print Club machine can output a high-quality print based on the congeniality between the Print Club machine and the roll paper in color amendment and portability.

However, there are various types of roll paper distributed in the market, and there can be the case in which roll paper not appropriate for the Print Club machine is mounted in the Print Club machine. In this case, a standard roll paper core pipe can carry an identification mark for the Print Club machine. However, the identification mark does not work when the standard core pipe is rolled by roll paper of other vendors.

Although Japanese Patent Application Publication Nos. 5-181884 and 6-325344 suggest methods of identifying roll paper, they require exclusive ink and readers, and it is hard to realize inexpensive systems in these methods.

In the method of Japanese Utility Model Application Publication No. 5-71965, it is easy to apply a copied security mark to the paper, resulting in a wrong application.

### SUMMARY OF THE INVENTION

The present invention has been developed to solve the above-mentioned problems, and aims at providing cheap and high-security-level roll printing paper which can be used only on the applicable Print Club machine.

The present invention according to first aspect is printing paper for use on a printer, and includes: roll paper having an information code configured by arranging data marks in a scanning direction, and read by a first read sensor for scanning the information code on the printer; and a rotor rolled by the roll paper and has an information code arranged and configured circularly on a perimeter or an end face, and read by a second read sensor for scanning the information code on the printer when the rotor rotates.

According to the present invention of the first aspect, when the printing paper is set on a printer, the second read sensor scans and reads the information code on the perimeter or the end face when the rotor rotates, and the first read sensor scans and reads the information code on the roll paper, thereby determining whether or not they correspond to each other. If they correspond to each other, it is determined that the rotor is rolled by designated roll paper. If they do not correspond to each other, it is determined that the rotor is rolled by wrong roll paper. According to the present invention of the first aspect, since wrong roll paper rolled around a rotor can be detected, a correct rotor loaded with wrong roll paper can be detected and rejected.

The present invention according to second aspect comprises printing paper of the first aspect wherein the information code of the roll paper includes a unique security code assigned to a printer which uses the printing paper.

According to the present invention of the second aspect, since the information code of the roll paper includes a unique security code assigned to a printer on which the printing paper is used, it is determined whether or not the information code of the roll paper corresponds to the information code of the rotor, and it is also determined whether or not the security code of the information code of the roll paper corresponds to the security code stored or held in, or transferred to the printer, etc., thereby double checking the codes. Since the security code is uniquely assigned to a printer on which the printing paper is used, it can be determined whether or not the user is using designated roll paper on the printer by determining whether or not the security code stored or held in, or transferred to the printer corresponds to the security code of the roll paper. According to the present invention of the second aspect, it is determined whether or not a user uses designated roll paper, and wrong roll paper can be more strictly rejected.

The present invention according to third aspect comprises printing paper of the first aspect or the second aspect wherein the information code of the rotor includes a unique security code assigned to a printer which uses the printing paper.

According to the present invention of the third aspect depending the first aspect, since the information code of the rotor includes a unique security code assigned to a printer on which the printing paper is used, it is determined whether or not the information code of the roll paper corresponds to the information code of the rotor, and it is also determined whether or not the security code of the information code of the rotor corresponds to the security code stored or held in, or transferred to the printer, etc., thereby double checking the codes. Since the security code is uniquely assigned to a printer on which the printing paper is used, it can be determined whether or not the user is using a designated rotor on the printer by determining whether or not the security code stored or held in, or transferred to the printer corresponds to the security code of the rotor. According to the present invention of the third aspect depending the first aspect, since it is determined whether or not a user uses a predetermined rotor on a printer, wrong roll paper can be more strictly rejected.

According to the present invention of the third aspect depending the second aspect, since the information code of the roll paper and the information code of the rotor include a unique security code assigned to a printer on which the printing paper is used, it is determined whether or not the information code of the roll paper corresponds to the information code of the rotor, or without determining whether or not the information code of the roll paper corresponds to the information code of the rotor, and it is also determined whether or not the security code of the information code of the roll paper and the security code of the information code of the rotor correspond to the security code stored or held in, or transferred to the printer, etc., thereby double checking the codes. Since the security code is uniquely assigned to a printer on which the printing paper is used, it can be determined whether or not the user is using designated roll paper and rotor on the printer by determining whether or not the security code stored or held in, or transferred to the printer corresponds to the security code of the roll paper and the security code of the rotor. According to the present invention of the third aspect depending the second aspect, since it is determined whether or not a user uses predetermined roll paper and rotor on a printer, wrong roll paper can be more strictly rejected.

The invention according to fourth aspect is printing paper, and includes: roll paper having an information code configured by arranging data marks in a scanning direction; and a rotor rolled by the roll paper and has an information code arranged and configured circularly on a peripheral face or an end face.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 shows the outline of the printer for use on the Print Club machine;

FIG. 2 is a perspective view showing the state of drawing a small amount of roll paper;

FIG. 3 shows the configuration of the information code of roll paper and the information code of a paper pipe;

FIG. 4 shows the information recorded on the information code of roll paper and the information code of a paper pipe; and

FIG. 5 is a flowchart of the procedure of comparing the security information portions contained in the read information code of roll paper and a paper pipe with the security code of the comparator.

### DETAILED DESCRIPTION OF THE PREFERRED EMBODIMENTS

The preferred embodiments of the printing paper according to the present invention are described below by referring to the attached drawings.

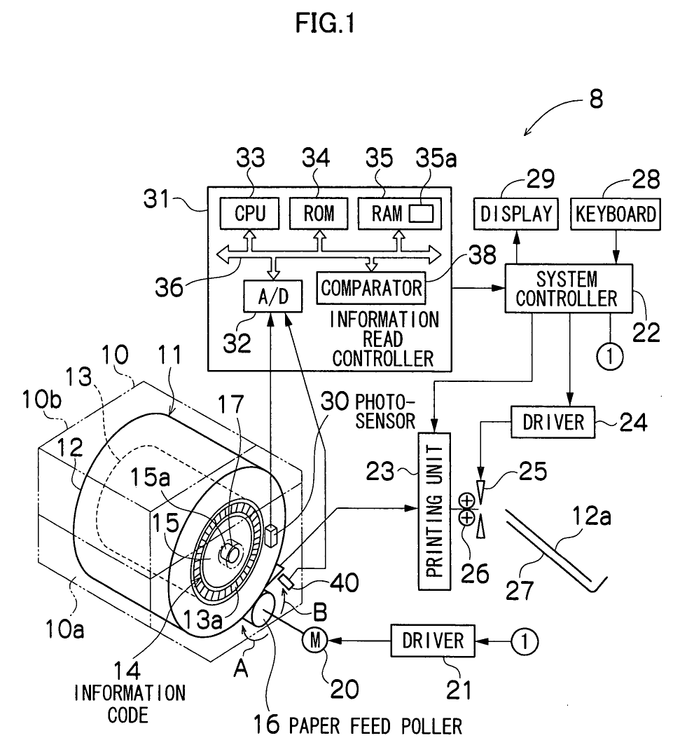

FIG. 1 shows the outline of a printer 8 for use on the Print Club machine. The printer 8 is a sublimation printer which is a type of thermal transfer printer, sublimates ink by heating an ink ribbon to which solid ink is applied using a print head, and makes the ink adhere to the exclusive paper coated with polyester resin.

In FIG. 1, a paper feed magazine 10 stores printing paper 11 which is the exclusive paper for the printing. The printing paper 11 is configured by rolling roll paper 12 around a paper pipe 13. The paper pipe 13 is configured by a paper or plastic cylinder, and an information code 14 is recorded on an end face 13a of the paper pipe 13. A paper holder 15 is embedded on both ends of the paper pipe 13. The paper holder 15 has a rotation axis 15a. The roll paper 12 is held such that it can freely rotate in the paper feed magazine 10 using the rotation axis 15a.

The paper feed magazine 10 is configured by a magazine body 10a and a magazine cover 10b. A paper feed roller 16 and a roll paper bearing 17 are provided in the paper feed magazine 10. The paper feed roller 16 feeds the roll paper 12 from the paper feed magazine 10 by touching the roll paper 12 and rotating in the direction indicated by the arrow A. By rotating in the direction indicated by the arrow B, the roll paper 12 can be rolled into the paper feed magazine 10.

The roll paper bearing 17 holds the rotation axis 15a of the paper holder 15 such that it can freely rotate. The roll paper bearing 17 is configured such that it freely travels in the direction of the paper feed roller, and the roll paper 12 can constantly touch the paper feed roller 16 although the diameter of the roll becomes smaller as the roll paper 12 is used. The paper feed roller 16 is driven by a paper feed motor 20. The paper feed motor 20 is rotation-controlled by a system controller 22 through a driver 21.

During printing, the paper feed motor 20 turns the paper feed roller 16 in the paper feed direction (A direction) to feed the roll paper 12 to a printing unit 23. A control signal is transmitted from the system controller 22 to the printing unit 23, and the printing unit 23 heats using a print head an ink ribbon to which solid ink is applied, thereby sublimating the ink, and makes the sublimated ink adhere onto the roll paper 12. After the adhesion, a control signal is transmitted from the system controller 22 to a driver 24, and a cutter 25 operates through the driver 24.

The cutter 25 cuts the printed portion of the roll paper 12 off the unprinted portion. An output roller 26 sets the roll paper 12 in the cutting position. A roll paper 12a cut by the cutter 25 is ejected into a tray 27.

As shown in FIG. 1, the information code 14 is formed by arranging the data marks on the end face of the paper pipe 13. When the printer 8 is powered up, the paper pipe 13 makes substantially one turn, and the information code 14 is read by a photosensor 30, and a read signal is transmitted to an A/D converter 32.

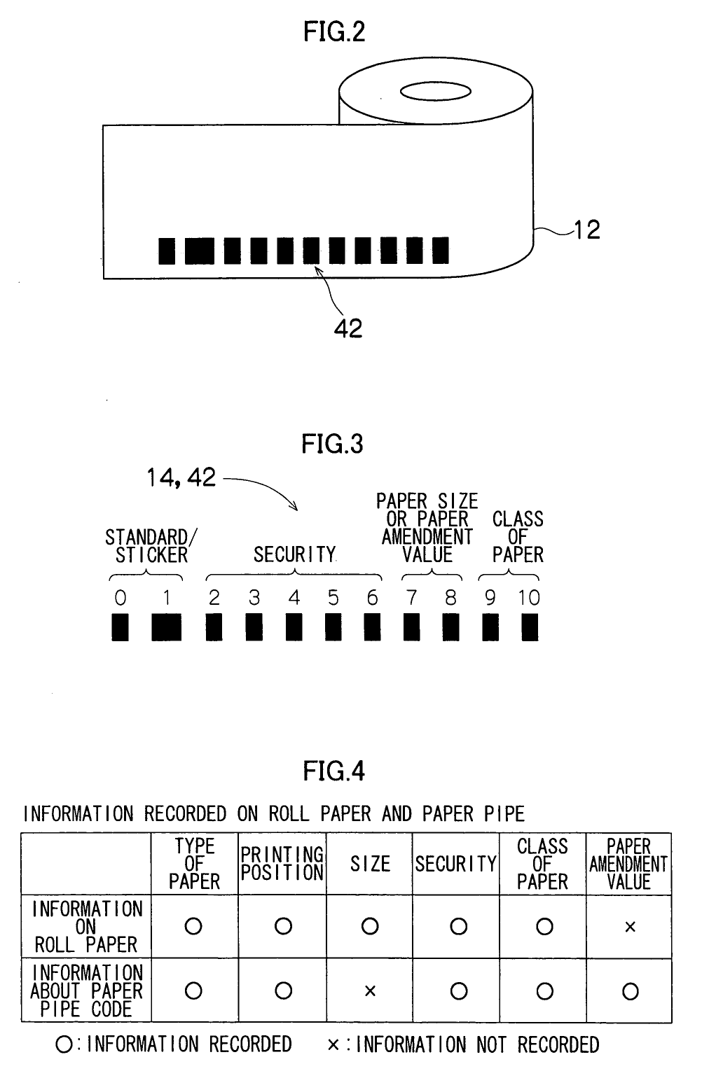

FIG. 2 is an oblique view showing the state of drawing a small amount of roll paper 12. As shown in FIG. 2, the roll paper 12 has an information code 42 configured by arranging data marks in the scanning direction. When the printing process is started, the paper feed roller 16 rotates in the A direction, one print page of the roll paper 12 is drawn, and the information code 42 of the roll paper 12 is read by a photosensor 40, and a read signal is transmitted to the A/D converter 32.

A keyboard 28 which is an information input device and a display 29 which is an information display device are connected to the system controller 22. An information read controller 31 is also connected to the system controller 22, and the printer control information obtained by the information read controller 31 is transmitted to the system controller 22

The information read controller 31 comprises the A/D converter 32, a CPU 33, ROM 34, RAM 35 having data memory 35a, and a comparator 38. These A/D converter 32, CPU 33, ROM 34, RAM 35, and comparator 38 are connected through a bus 36. The ROM 34 stores a unique security code provided for the printer 8.

The information code 42 of the roll paper 12 and the information code 14 of the paper pipe 13 are configured as shown in FIG. 3, and the information recorded respectively in the information codes 42 and 14 is shown in FIG. 4.

The information code 42 and 14 has 11 data marks 0 to 10, and only the data mark “1” is twice as wide as the others. The 11 data marks are repeatedly assigned as the information codes 42 and 14 in the longitudinal direction of the roll paper 12 and circularly about the paper pipe 13.

The data marks “0” and “1” indicate the types of paper, that is, standard paper and sticker respectively. The data mark “1” is also an indicator indicative of a print starting position.

The data marks “2”, “3”, “4”, “5”, and “6” indicate security codes. The security codes are configured to correspond to designated printers.

The data marks “7” and “8” indicate the paper sizes for the information code 42 of the roll paper 12, and the paper amendment value for the information code 14 of the paper pipe 13. The paper amendment value indicates the sensitivity of paper. The data marks “7” and “8” are also configured to correspond to designated printers.

The data marks “9” and “10” indicate the class of paper. That is, for example, the Print Club machine output ¼ stickers or ⅛ stickers. The data marks “9” and “10” are also configured to correspond to designated printers.

Described below is how the information code 42 of the roll paper 12 and the information code 14 of the paper pipe 13 are actually read and operate the printer 8.

When the printer 8 is powered up, the paper pipe 13 makes substantially one turn, the information code 14 is read by the photosensor 30, and the read signal is transmitted to the A/D converter 32. The printer 8 is powered up when, for example, a shop or an arcade of the Print Club machine opens its doors. The read signal transmitted to the A/D converter 32 is stored in the data memory 35a of the RAM 35.

Before starting printing, the security codes stored in the ROM 34 are sequentially transmitted to the comparator 38.

When the printing operation is started, roll paper of one print page of the paper feed roller 16 is drawn as it rotates in the A direction. While it is drawn, the information code 42 of the roll paper 12 is read by the photosensor 40, and the read signal is transmitted to the A/D converter 32. The read signal transmitted to the A/D converter 32 is stored in the data memory 35a of the RAM 35.

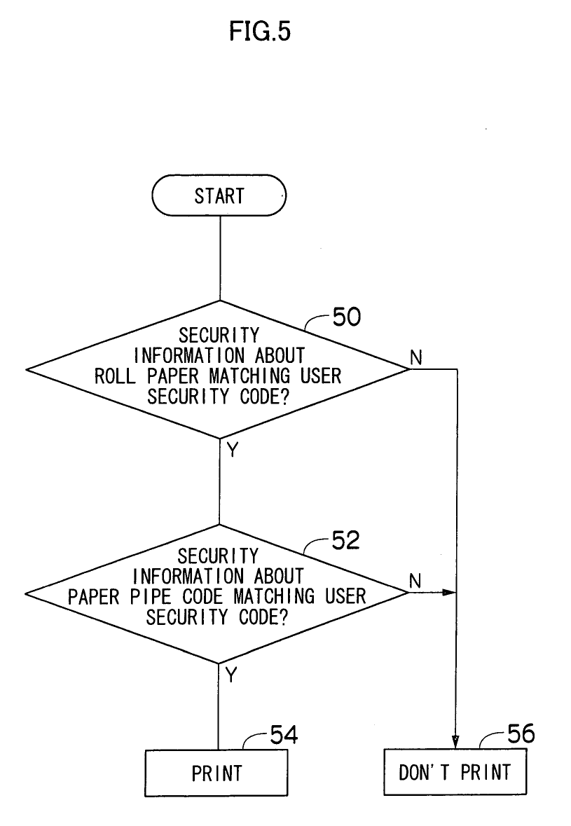

The security information portions contained in the information codes 14 and 42 are sequentially transmitted to the comparator 38, and compared with the security codes of the comparator 38. FIG. 5 is a flowchart showing the procedure of the comparison.

First, the security information portion of the information code 42 of the roll paper 12 is compared with the security code of the printer 8 of the comparator 38 (step 50). If the comparison result is “non-matching”, it is determined that the printer 8 is not loaded with designated roll paper, and printing is not performed (step 56). If the comparison result is “matching”, control is passed to the next step 52.

In step 52, the security information portion of the information code 14 of the paper pipe 13 is compared with the security code of the printer 8 of the comparator 38. If the comparison result is “non-matching”, it is determined that the printer 8 is not loaded with a designated paper pipe, and printing is not performed (step 56). If the comparison result is “matching”, it is determined that the printer 8 is loaded with designated roll paper and paper pipe, and printing is performed (step 54).

The procedure shown in FIG. 5 is controlled by the CPU 33.

As described above, in the printing paper 11, a higher level of security can be guaranteed at a lower cost by providing the roll paper 12 and the paper pipe 13 respectively with the information codes 42 and 14.

That is, only assigning an information code to a paper pipe is not sufficient to protect the security because wrong roll paper can be loaded on the paper pipe. However, according to the present embodiment, it is necessary for a user to correctly prepare both roll paper and a paper pipe. As a result, wrong printing paper cannot be used.

Furthermore, although the paper amendment value cannot be recorded due to the restriction on the number of data marks by using only the information code 42 of the roll paper 12, the value can be recorded using the information code 14 of the paper pipe 13 according to the present embodiment, thereby enhancing the quality of the printed image.

Additionally, according to the present embodiment, a security code is assigned to the comparator 38, and it is determined whether or not the security code corresponds to the information code 42 of the roll paper 12, and whether of not the security code corresponds to the information code 14 of the paper pipe 13. It is also possible to directly determine whether or not the information code 42 of the roll paper 12 corresponds to the information code 14 of the paper pipe 13.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. Printing paper for use on a printer, comprising:
roll paper having an information code configured by arranging data marks in a scanning direction, and read by a first read sensor for scanning the information code on the printer; and
a rotor rolled by said roll paper and has an information code arranged and configured circularly on a perimeter or an end face, and read by a second read sensor for scanning the information code on the printer when said rotor rotates.

2. The printing paper according to claim 1, wherein the information code of said roll paper includes a unique security code assigned to a printer which uses said printing paper.

3. The printing paper according to claim 1, wherein the information code of said rotor includes a unique security code assigned to a printer which uses said printing paper.

4. The printing paper according to claim 2, wherein the information code of said rotor includes a unique security code assigned to a printer which uses said printing paper.

5. Printing paper, comprising:
roll paper having an information code configured by arranging data marks in a scanning direction; and
a rotor rolled by said roll paper and has an information code arranged and configured circularly on a peripheral face or an end face.
